(19) United States
(12) Patent Application Publication
(10) Pub. No.: US 2012/0176814 A1
(43) Pub. Date: Jul. 12, 2012

(54) Display module

(76) Inventors: Jae-Mo Chung, Yongin-City (KR); Sung-Hwan Kim, Yongin-city (KR)

(21) Appl. No.: 13/137,809

(22) Filed: Sep. 14, 2011

(30) Foreign Application Priority Data
Jan. 10, 2011 (KR) 10-2011-0002301

(51) Int. Cl. F21V 8/00

(52) U.S. Cl. 362/613

(57) ABSTRACT

A display module includes a display panel that displays an image, a backlight having a light guide panel that guides light onto the display panel and an optical unit including a circuit board, and a housing unit having a mold frame. The circuit board has mounted thereon a plurality of light source elements that supply light into the light guide panel. The light guide panel is accommodated in the mold frame. The mold frame includes at least one accommodation groove in which the light source elements are accommodated, and a separation preventing portion on an inner sidewall of the mold frame that is in contact with the at least one accommodation groove.

### CROSS-REFERENCE TO RELATED PATENT APPLICATION

This application claims the benefit of Korean Patent Application No. 10-2011-0002301, filed on Jan. 10, 2011, in the Korean Intellectual Property Office, the disclosure of which is incorporated herein in its entirety by reference.

### BACKGROUND

Display modules may include a liquid crystal display panel that is a light-receiving display device and that displays an image not by self-emitting light but by receiving external light. The display modules may also include a light source element for emitting light and a light guide panel. For example, in order for a liquid crystal display panel to be a self-emissive display, since a liquid crystal display module itself is not self-emissive, a back light unit may be installed on a rear surface of the liquid crystal display panel to emit light. Accordingly, an image may be observed even in a dark place.

### SUMMARY

Embodiments may be realized by providing a display module including a display panel for displaying an image; a backlight including a light guide panel for guiding light onto the display panel and an optical unit including a circuit board for light source elements, wherein a plurality of light source elements for supplying light into the light guide panel are mounted on the circuit board; and a housing unit including a mold frame in which the light guide panel is accommodated, wherein at least one accommodation groove in which the light source elements are accommodated is formed in the mold frame, and a separation preventing portion is formed on an inner sidewall of the mold frame that is in contact with the at least one accommodation groove.

A side portion of the light guide panel may be disposed in front of the light source elements, and the separation preventing portion may be disposed behind the light source elements.

The separation preventing portion may be formed on the inner wall of the mold frame and the inner wall corresponds to a rear surface of the light source elements opposite to the side portion of the light guide panel.

The separation preventing portion may be in the form of a protrusion protruded from the inner sidewall.

A surface of the separation preventing portion corresponding to the rear surface of the light source elements may be curved.

A plurality of the accommodation grooves may be spaced apart at predetermined intervals along a side of the mold frame, and the separation preventing portion may be formed in an outermost accommodation groove among the plurality of accommodation grooves.

The separation preventing portion may be formed as a protrusion on the inner sidewall of the mold frame and the inner sidewall may correspond to a rear surface of the light source elements opposite to a side portion of the light guide panel.

A surface of the separation preventing portion corresponding to a rear surface of the light source element may be curved.

An accommodation portion may be formed on an edge of a sidewall portion of the mold frame, and the accommodation portion may comprise a flat panel portion that is curved from an end portion of the sidewall portion, a plurality of convex portions protruded from a front edge of the flat panel portion toward the light guide panel, and a plurality of the accommodation grooves formed in the intervals between the convex portions and in which the light source elements are disposed.

The circuit board may surround an external surface of the sidewall portion of the mold frame and be disposed above the accommodation portion, and a plurality of light source elements arranged on the circuit board may be separately located in the accommodation grooves.

The separation preventing portion may be formed in the form of a protrusion protruding from an inner sidewall of the flat panel portion corresponding to a rear surface of the light source elements opposite to a side portion of the light guide panel.

A surface of the separation preventing portion corresponding to the rear surface of the light source elements may be curved.

A plurality of the accommodation grooves may be spaced apart at predetermined intervals along a side of the mold frame, and the separation preventing portion may be formed in the form of a protrusion protruding from an inner sidewall of the flat panel portion in an outermost accommodation groove among the plurality of accommodation grooves.

### BRIEF DESCRIPTION OF THE DRAWINGS

Features will become apparent to those of ordinary skill in the art by describing in detail exemplary embodiments with reference to the attached drawings in which:

FIG. 1 illustrates a partial perspective view of a display module according to an exemplary embodiment;

FIG. 2 illustrates a plan view of the display module of FIG. 1, according to an exemplary embodiment;

FIG. 3 illustrates an expanded perspective view of a portion of the display module of FIG. 1 where an exemplary separation preventing portion is formed;

FIG. 4 illustrates a plan view showing light source elements of FIG. 1 in an exemplary twisted state;

FIG. 5 shows a graph of brightness dispersions for the display module of FIG. 1 having different gaps between a light guide panel and a light source element; and

FIG. 6 illustrates a plan view of a display module according to an exemplary embodiment.

### DETAILED DESCRIPTION

Korean Patent Application No. 10-2011-0002301, filed on Jan. 10, 2011, in the Korean Intellectual Property Office, and entitled “Display Module,” is incorporated by reference herein in its entirety.

Though embodiments allows for various changes and numerous embodiments, only exemplary embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed. In the description, certain detailed explanations of related art are omitted when it is deemed that they may obscure the essence of the invention.

While such terms as “first,” “second,” etc., may be used to describe various components, such components are not limited to the above terms. The above terms are used only to distinguish one component from another.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of features, numbers, steps, actions, components, parts, or combinations thereof disclosed in the specification, and are not intended to preclude the possibility that one or more other features, numbers, steps, actions, components, parts, or combinations thereof may exist or may be added.

A display module according to exemplary embodiments will be described below in more detail with reference to the accompanying drawings. Those components that are the same or are in correspondence are rendered the same reference numeral regardless of the figure number, and redundant explanations are omitted.

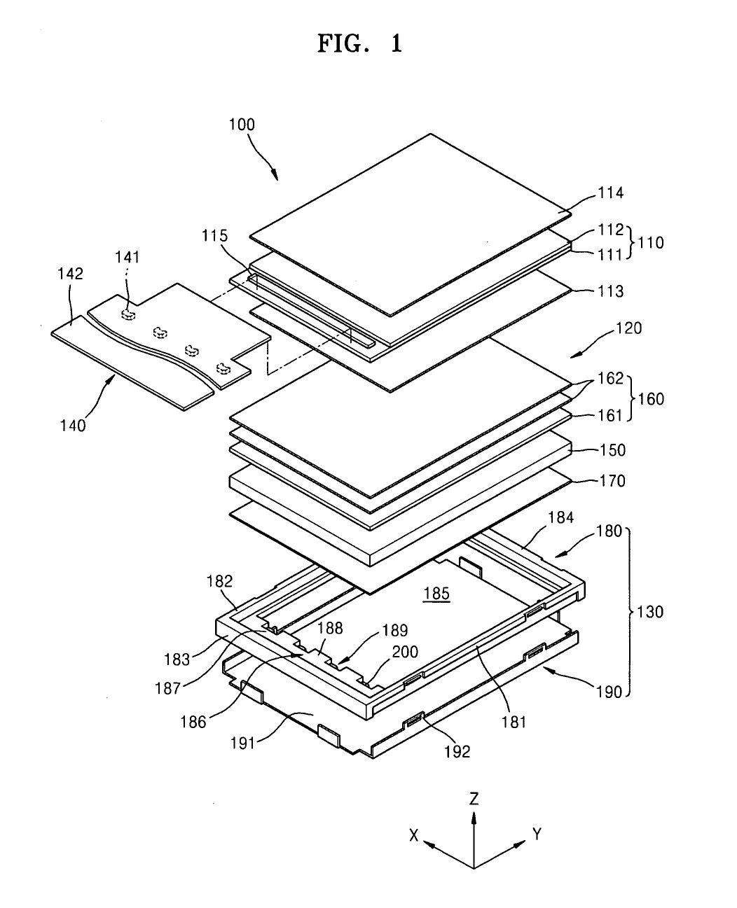

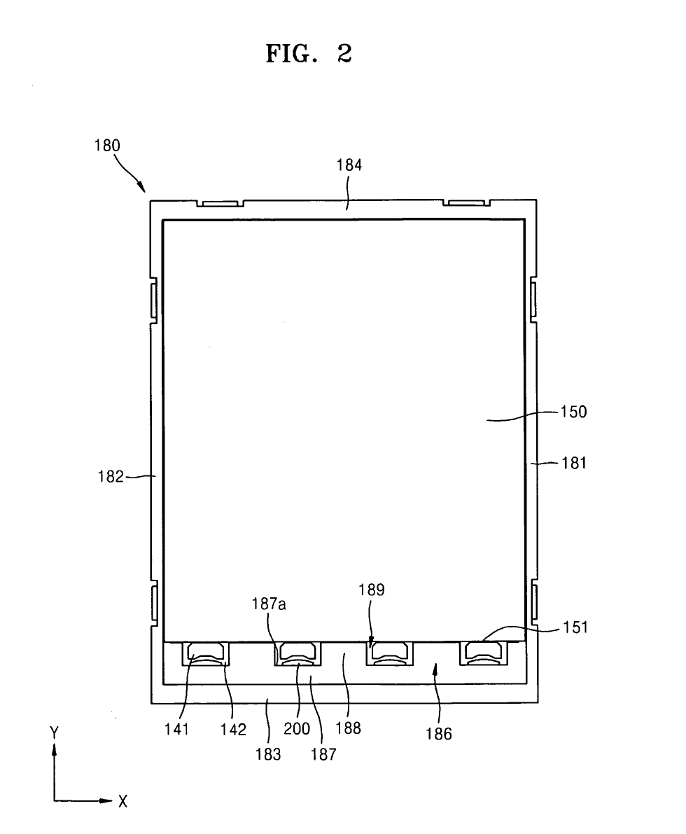

FIG. 1 illustrates a partial perspective view of a display module 100 according to an exemplary embodiment. FIG. 2 illustrates a plan view of the display module 100, according to an exemplary embodiment.

Referring to FIGS. 1 and 2, the display module 100 may include a display panel 110, a backlight unit 120, and a housing unit 130. The backlight unit 120 may include a light source unit 140, a light guide panel 150, a plurality of optical sheets 160, and a reflection sheet 170.

The display panel 110 may include a first substrate 111, a second substrate 112 disposed to face the first substrate 111, and liquid crystals (not shown) injected between the first substrate 111 and the second substrate 112. In the current embodiment, the display panel 110 is described as a liquid crystal display panel, but the display panel 110 is not limited to this type and may be other types of light-receiving display panels.

A first polarization plate 113 may be attached on an external surface of the first substrate 111, and a second polarization plate 114 may be attached on an external surface of the second substrate 112. The first polarization plate 113 may polarize light that has passed through the optical sheets 160 in, e.g., a direction perpendicular to a polarization direction, and may emit the polarized light toward the display panel 110. The second polarization plate 114 may polarize light that has passed through the display panel 110, e.g., in a direction perpendicular to the polarization direction, and may emit the polarized light to the outside.

A driver IC 115 may be mounted on an edge of the first substrate 111. The driver IC 115 may generate a driving signal to operate the display panel 110 according to a voltage applied from the outside. The driver IC 115 may be electrically connected to the display panel 110 using a conductive adhesive such as an anisotropic conductive film (ACF).

The light source unit 140 may include a plurality of light source elements 141 for supplying light to a side portion 151 of the light guide panel 150, and a circuit board 142 on which the light source elements 141 are mounted.

The light source elements 141 may each be, e.g., one of a cold cathode fluorescent lamp (CCFL), an external electrode fluorescent lamp (EEFL), or a light emitting diode (LED). According to an exemplary embodiment, to emit white light, at least one LED may be used as each or in each of the light source elements 141. The number of light source elements 141 may be varied according to a size of the display panel 110 and a desired brightness thereof. The light source elements 141 may be spaced apart from one another at predetermined intervals on the circuit board 142.

The circuit board 142 may be electrically connected to the edge of the first substrate 111, and may transmit an electrical signal to the display panel 110. The circuit board 142 may be a flexible printed circuit (FPC) board or a hard printed circuit board (HPCB). The FPC board having flexibility may be practical as the circuit board 142.

The light guide panel 150 may be disposed below the display panel 110. The light guide panel 150 may provide light emitted from the light source elements 141 to the display panel 110. The light guide panel 150 may be patterned to have a predetermined pattern in order to, e.g., be a uniform surface light source.

The optical sheets 160 may be interposed between the display panel 110 and the light guide panel 150. The optical sheets 160 may include at least one sheet to, e.g., improve brightness efficiency. According to an exemplary embodiment, the optical sheets 160 may include a diffusion sheet 161 for diffusing light emitted from the light guide panel 150 and at least one prism sheet 162 for condensing the light in a forward direction. The optical sheets 160 may diffuse and condense light guided by the light guide panel 150 in order for the light to be more uniformly incident on the display panel 110.

The reflection sheet 170 may be installed on a rear surface of the light guide panel 150 opposite to the optical sheets 160. The reflection sheet 170 may reflect light that has transmitted out of the rear surface of the light guide panel 150 to the display panel 110. The reflection sheet 170 may contain a material having a high light reflectivity such as silver (Ag) to increase brightness efficiency.

The housing unit 130 may include a mold frame 180 and a case 190.

The mold frame 180 may provide space for accommodating the light guide panel 150, the optical sheets 160, and the reflection sheet 170. The mold frame 180 may be frame, e.g., a rectangular frame, having an opening in its center. The mold frame 180 may be formed of a polymer. The mold frame 180 may be mounted in the case 190. For example, the mold frame 180 may be on, e.g., mounted to, the sides of the case 190 to form a frame that surrounds, e.g., completely surrounds, the case 190.

The case 190 may include a bottom portion 191 on which the mold frame 180 is mounted and a sidewall portion 192 that is bent from an edge of the bottom portion 191 in a vertical direction. The sidewall portion 192 may be coupled to the mold frame 180 by a coupling method such as a hook coupling method. The case 190 may be formed of a metal having relatively high rigidity, such as aluminum. Meanwhile, a cover case (not shown) that is coupled to the case 190 to cover the display panel 110, the backlight unit 120, and the mold frame 180 may be further formed above the case 190.

A plurality of accommodation grooves 189 capable of accommodating the light source elements 141 may be formed in the mold frame 180. A separation preventing portion 200 may be formed on an inner wall of the mold frame 180 that contacts the accommodating grooves 189. This will be described further in detail.

The mold frame 180 may include a first long side sidewall portion 181, a second long side sidewall portion 182, a first short side sidewall portion 183, and a second short side sidewall portion 184. The first long side sidewall portion 181 and the second long side sidewall portion 182 may be strips, e.g., elongated portions, that are disposed to face each other in an first direction, e.g., an X-direction. The first short side sidewall portion 183 and the second short side sidewall portion 184 may be strips that are disposed to face each other in a second direction, e.g., a Y-direction. The first direction may intersect the second direction, e.g., the first direction may be perpendicular to the second direction. The portions 181, 182, 183, and 184 of the mold frame 180 may be integrally formed or may be separated pieces connected together.

Two end portions of the first short side sidewall portion 183 may be connected to a first end portion of the first long side sidewall portion 181 and a first end portion of the second long side sidewall portion 182, respectively. Two end portion of the second short side sidewall portion 184 may be connected to a second end portion of the first long side sidewall portion 181 and a second end portion of the second long side sidewall portion 182, respectively. Accordingly, the mold frame 180 may be formed as a rectangular frame, and an opening 185 may be formed in its center.

An accommodation portion 186 may extend from a lower edge of the first short side sidewall portion 183 toward and/or into the opening 185. The circuit board 142 on which the light source elements 141 are mounted may be located on the accommodation portion 186.

The accommodation portion 186 may include a flat panel portion 187 that is bent from a lower portion of the first short side sidewall portion 183. The flat panel portion 187 may be formed with a plurality of protrusions and projections that face the opening 185. The flat panel portion 187 may extend along a lengthwise direction of the first short side sidewall portion 183.

A plurality of convex portions 188 having a predetermined size may protrude into the opening 185 from a front edge of the flat panel portion 187. The convex portions 188 may be formed with the front edge of the flat panel portion 187 as a single unit, e.g., may be integrally formed with the flat panel portion 187. The convex portions 188 may be spaced apart at predetermined intervals along the lengthwise direction of the first short side sidewall portion 183. Accordingly, a plurality of accommodation grooves 189 may be formed in the intervals between the convex portions 188.

The light source unit 140 may be located on the accommodation portion 186.

A first end portion of the circuit board 142 may be electrically connected to the edge of the first substrate 111. The circuit board 142 may be flexible and may surround an external surface of the first short side sidewall portion 183. A second end portion of the circuit board 142 may be disposed on a lower surface of the accommodation portion 186 facing the bottom portion 191 of the case 190.

According to an exemplary embodiment, the circuit board 142 may surround the external surface of the first short side sidewall portion 183. However, as long as an end portion of the circuit board 142 is disposed on an upper surface or a lower surface of the accommodation portion 186, the circuit board 142 is not limited to any single structure.

The light source elements 141 may be disposed in respective grooves 189 of the plurality of accommodation grooves 189. The side portion 151 of the light guide panel 150 may be disposed in front of the light source elements 141. The accommodation grooves 189 may have tetragonal cross-sections corresponding to an external form of the light source elements 141, but are not limited thereto.

In consideration of assembly tolerance of the light source elements 141, when accommodating the light source elements 141, the accommodation grooves 189 may be larger than the light source elements 141 with respect to both or one of the X and Y axes. Without intending to be bound by this theory, brightness dispersion occurs according to a degree of closeness between the light source elements 141 and the side portion 151 of the light guide panel 150.

For example, assuming the light source elements 141 are relatively close to the side portion 151 of the light guide panel 150, if the light source elements 141 are separated from the side portion 151 due to assembly error, a relatively high degree of brightness dispersion is generated if the light source elements 141 rotate a relatively great amount. This occurs because the light source elements 141 are not located in their proper positions, e.g., if they are accommodated in an arrangement of the accommodation grooves 188, but are still able to be rotated by a predetermined angle. In order to reduce brightness dispersion, the separation preventing portion 200, which may minimize a separation degree of the light source elements 141 with respect to the side portion 151 of the light guide panel 150, may be formed on an inner sidewall 187a of the flat panel portion 187.

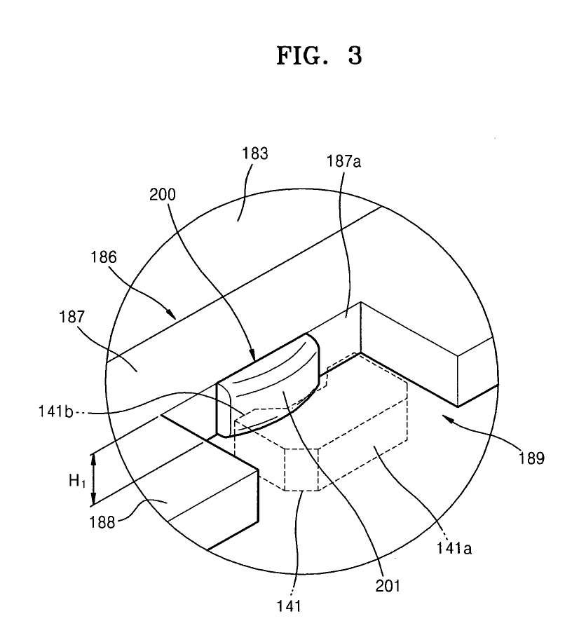

FIG. 3 illustrates an expanded perspective view of a portion of the display module 100 of FIG. 1 where the separation preventing portion 200 is formed.

Referring to FIG. 3, the separation preventing portion 200 may be formed on the inner sidewall 187a of the flat panel portion 187. The separation preventing portion 200 may be formed as a protrusion having a predetermined size and protruded from the inner sidewall 187a of the flat panel portion 187 toward the light source elements 141. The separation preventing portion 200 may be disposed in each or some of the accommodation grooves 189. An area where the separation preventing portion 200 is formed may correspond to the inner sidewall 187a of the flat panel portion 187. The inner sidewall 187a may correspond to a rear surface 141b of the light source elements 141 opposite to the side portion 151 of the light guide panel 150 (see FIG. 2).

The separation preventing portion 200 may be in the form of a pillar having a curved front surface 201. The front surface 201 of the separation preventing portion 200 may be curved in order to, e.g., allow the light source elements 141 to slide on the front surface 201 of the separation preventing portion 200 and thus to easily be located in the accommodation grooves 189 when the light source elements 141 are inserted into the accommodation grooves 189. The curved front 201 of the separation preventing portion 200 may correspond to an opposing surface on the light source elements 141. For example the curved front surface 201 may be a protrusion and the light source elements 141 may include an indentation corresponding to the protrusion of the curved front surface 201. According to an exemplary embodiment, the separation preventing portion 200 may be in the form of a pillar-shaped protrusion but is not limited thereto. For example, the separation preventing portion 200 may have any structure that is curved on the inner sidewall 187a of the flat panel portion 187.

The separation preventing portion 200 may have a height H1 that corresponds to a thickness of the flat panel portion 187. According to an exemplary embodiment, the height H1 of the separation preventing portion 200 is substantially the same as the thickness of the flat panel portion 187. However, embodiments of the separation preventing portion 200 are not limited thereto. For example, the separation preventing portion 200 may have any structure that protrudes from the inner sidewall 187a of the flat panel portion 187 and is capable of supporting the rear surface 141b of the light source elements 141 even when the light source elements 141 are rotated after being assembled.

The separation preventing portion 200 may be formed, e.g., in a protruding manner, such that a gap between the side portion 151 of the light guide panel 150 and a front surface 141a of the light source elements 141 may not be more than about 0.1 millimeter at the greatest. This gap may have a size, with which the front surface 141a of the light source elements 141 is still supported by the rear surface 141b of the light source elements 141 even when the light source elements 141 are inclined when the front surface 141a of the light source elements 141 are disposed in the accommodation grooves 189, and thus brightness dispersion may be reduced accordingly.

In regard to a manufacturing process, the separation preventing portion 200 may be molded with the mold frame 180, e.g., referring to FIG. 2, as a single unit when molding the mold frame 180, and be formed of the same material as the mold frame 180. The separation preventing portion 200 may be formed of an elastic material so as to selectively support the rear surface 141b of the light source elements 141.

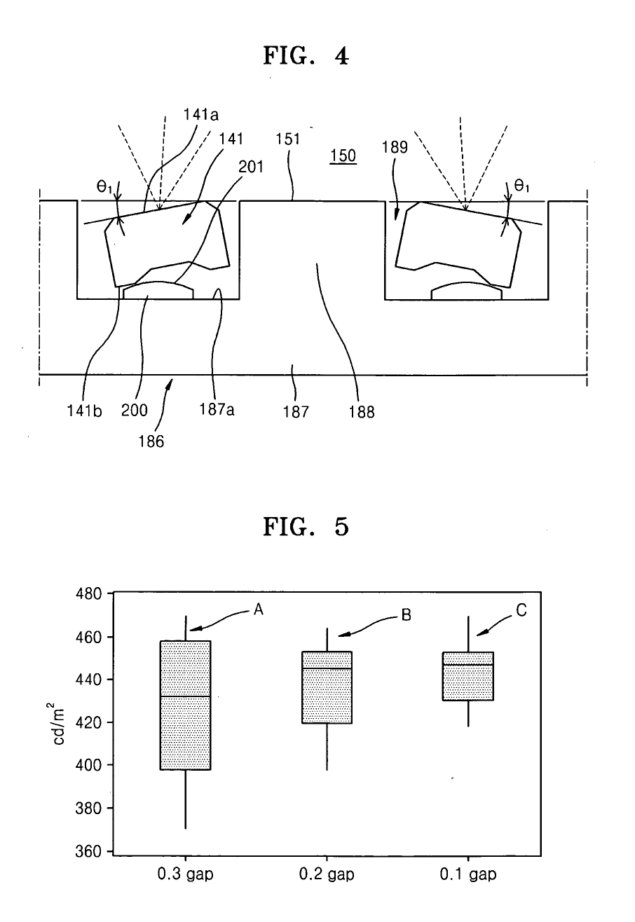

FIG. 4 illustrates a plan view showing the light source elements 141 of FIG. 1 in a twisted state.

Referring to FIG. 4, during an assembling operation in which the light source elements 141 are inserted into the accommodation grooves 189, the front surface 141a of the light source elements 141 may not be relatively close to a surface corresponding to the side portion 151 of the light guide panel 150 but are twisted at an angle θ1 of, e.g., about 4°.

Even when the light source elements 141 are included and mounted in the accommodation grooves 189, the rear surface 141b of the light source elements 141 may be supported by the inclined front surface 201 of the separation preventing portion 200. Thus, the front surface 141a of the light source elements 141 may not be separated from the side portion 151 of the light guide panel 150 by a distance of more than 0.1 millimeter.

As described above, due to the separation preventing portion 200, the light source elements 141 are protected and/or prevented from further twisting.

Thus, as described above with reference to FIGS. 1 through 3, the mold frame 180 may include the accommodation portion 186 formed on the lower edge of the first short side sidewall portion 183. A concave-convex structure formed of the convex portions 188 and the accommodation grooves 189 may be repeatedly arranged on the front edge of the flat panel portion 187 of the accommodation portion 186 along the lengthwise direction of the first short side sidewall portion 183.

The separation preventing portion 200 may protrude in, e.g., a pillar form, from the inner sidewall 187a of the flat panel portion 187 corresponding to the rear surface 141b of the light source elements 141, and the front surface 201 thereof is curved. Accordingly, when the light source elements 141 are inserted into the accommodation grooves 189, the light source elements 141 may slide on the front surface 201 of the separation preventing portion 200 and be easily mounted in the accommodation grooves 189.

Table 1 shows brightness dispersion when there is a gap between the light guide panel 150 and the light source elements 141 according to experiments conducted by the inventor, and FIG. 5 is a graph illustrating the brightness dispersion.

TABLE 1

| | Brightness (cd/m²) | | |
|---|---|---|---|
| Sample | 0.3 gap (mm) | 0.2 gap (mm) | 0.1 gap (mm) |
| 1 | 462 | 449 | 431 |
| 2 | 398 | 413 | 454 |
| 3 | 435 | 443 | 448 |
| 4 | 430 | 453 | 454 |
| 5 | 439 | 451 | 450 |
| 6 | 450 | 455 | 425 |
| 7 | 412 | 453 | 419 |
| 8 | 470 | 433 | 471 |
| 9 | 397 | 411 | 457 |
| 10 | 380 | 412 | 431 |
| 11 | 371 | 438 | 448 |
| 12 | 387 | 456 | 427 |
| 13 | 413 | 398 | 449 |
| 14 | 456 | 454 | 445 |
| 15 | 415 | 431 | 444 |
| 16 | 460 | 456 | 460 |
| 17 | 468 | 454 | 436 |
| 18 | 450 | 465 | 420 |
| 19 | 459 | 424 | 455 |
| 20 | 398 | 419 | 452 |
| Minimum (Min) | 371 | 398 | 419 |
| Maximum (Max) | 470 | 465 | 471 |
| Average (Ave) | 427.5 | 438.4 | 443.8 |

Referring to Table 1 and FIG. 5, in Comparative example A, the gap between the side portion 151 of the light guide panel 150 and the front surface 141a of the light source elements 141 is 0.3 millimeter. In Comparative example B, the gap between the side portion 151 of the light guide panel 150 and the front surface 141a of the light source elements 141 is 0.2 millimeter. In Example C, according to an exemplary embodiment, a gap between the side portion 151 of the light guide panel 150 and the front surface 141a of the light source elements 141 is 0.1 millimeter.

In Comparative example A, a maximum brightness is 470 cd/m², a minimum brightness is 371 cd/m², and an average brightness is 427.5 cd/m². In Comparative example B, a maximum brightness is 465 cd/m², a minimum brightness is 398 cd/m², and an average brightness is 438.4 cd/m². In Example C, a maximum brightness is 471 cd/m², a minimum brightness is 419 cd/m², and an average brightness is 443.8 cd/m².

As described above, when the gap is 0.3 millimeter, as in Comparative example A, a difference between the minimum brightness and the maximum brightness is 99 cd/m². When the gap is 0.2 millimeter, as in Comparative example B, a difference between the minimum brightness and the maximum brightness is 67 cd/m². When the gap is 0.1 millimeter, as in Example C, a difference between the minimum brightness and the maximum brightness is 52 cd/m², indicating that brightness dispersion decreases as the gap decreases.

Furthermore, the average brightness is 427.5 cd/m² in Comparative example A where the gap is 0.3 millimeter, and the average brightness is 438.4 cd/m² in Comparative example B where the gap is 0.2 millimeter, and the average brightness is 443.8 cd/m² in Example C where the gap is 0.1 millimeter, indicating that brightness increases as the gap decreases.

As described above, since the separation preventing portion 200 may be installed on the inner sidewall 187a of the flat panel portion 187, the gap between the side portion 151 of the light guide panel 150 and the front surface 141a of the light source elements 141 may be reduced.

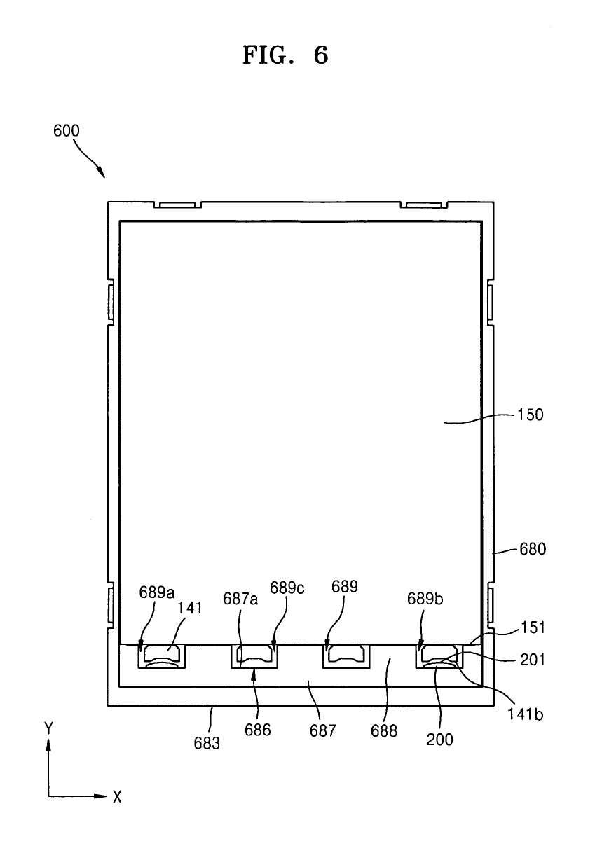

FIG. 6 illustrates a plan view illustrating a display module 600 according to another exemplary embodiment. Hereinafter, descriptions will focus on characteristic elements of the exemplary embodiment illustrated in FIG. 6.

Referring to FIG. 6, the display module 600 may include a mold frame 680 installed along a circumference of a light guide panel 150. An accommodation portion 686 may extend toward the light guide panel 150 from a lower edge of a short side sidewall portion 683 of the mold frame 680.

The accommodation portion 686 may include a flat panel portion 687 that extends along a lengthwise direction (X-direction) of the short side sidewall portion 683. A plurality of convex portions 688 that have a predetermined size, may protrude from a front edge of the flat panel portion 687 toward the light guide panel 150, and may be spaced apart at predetermined intervals. A plurality of accommodation grooves 689 may be formed in the intervals formed by the convex portions 688.

A plurality of light source elements 141 may be disposed in respective grooves 689 of the plurality of accommodation grooves 689. A side portion 151 of the light guide panel 510 may be disposed in front of the light source elements 141.

A separation preventing portion 200 may be disposed in a leftmost accommodation groove 689a and in a rightmost accommodation groove 689b among the plurality of accommodation grooves 689. The separation preventing portion 200 may have a pillar shape having a front surface 201 that is curved, as described above with reference to FIG. 3. When mounting the light source elements 141 in the accommodation grooves 689, the light source elements 141 may slide on the front surface 201 and thus may be easily inserted into the accommodation grooves 689. In contrast, the separation preventing portion 200 may not be disposed in at least one accommodation groove 689c among the plurality of the accommodation grooves 689.

As described above, the separation preventing portion 200, which may be formed as a single unit with an inner sidewall 687a of the flat panel portion 687 corresponding to the rear surface 141b of the light source elements 141 and inclined, may be disposed on two sides, that is, in the leftmost accommodation groove 689a and the rightmost accommodation groove 689b among the plurality of accommodation grooves 689. Thus, assembly defects may be reduced when mounting the light source elements 141 in the plurality of accommodation grooves 689.

As described above, the following effects may be obtained from a display module according to exemplary embodiments.

First, a separation preventing portion may be formed behind light source elements, and thus a gap between a light guide panel and the light source elements may be minimized even when assembly defects occurs. Accordingly, brightness dispersion may be reduced.

Second, as brightness dispersion may be reduced, components including light sources having low luminous intensity may be used. Accordingly, manufacturing costs may be reduced.

Third, a separation preventing portion 200 may include a curved portion, and thus light source elements may be easily installed.

By way of summation and review, display modules may include a light source element for emitting light. For example, a back light unit may be used for a surface light source element, such as a light element for a light up sign, in addition to a light-receiving display module, such as a liquid crystal display panel.

The backlight unit may be classified as a direct light type or as an edge light type according to a position of a light source element. The direct light type backlight unit may have a structure in which a plurality of light source elements disposed under a panel directly emit light onto the panel. The edge light type backlight unit may have a structure in which a plurality of light source elements disposed at a side of a light guide panel emit light and the emitted light is transmitted to a display panel through the light guide panel.

A light source of a backlight unit may be any of a cold cathode fluorescent lamp (CCFL), an external electrode fluorescent lamp (EEFL), a light emitting diode (LED), etc. The CCFL may have a structure in which electrodes of ends of a fluorescent lamp are formed inside a tube. The EEFL may have a structure in which electrodes of ends of a fluorescent lamp are formed outside of a tube. The LED has advantages such as a compact size, low power consumption, and high reliability, and thus has been widely used as a light source of a display module.

When an edge light type backlight unit is used as a light source of a liquid crystal display module, the light source may be mounted at a side of a light guide panel in order for light emitted from the light source to be irradiated into the light guide panel, and an additional mounting unit for mounting the light source may be formed at the side of the light guide panel. If the light source is not positioned as desired, e.g., if the light source is twisted by a predetermined angle, there is a gap between the side of the light guide panel and the light source, thereby reducing brightness of the display module.

Embodiments, as discussed above, provide display modules including a separation preventing portion in a portion where a light source element is accommodated in order to reduce a degree at which the light source element is out of a desired position and thus to improve brightness of the display modules. Accordingly, as the separation preventing portion is formed behind the light source elements, a gap between the light guide panel and the light source elements may be minimized even when assembly dispersion occurs, and thus brightness dispersion may be reduced.

Embodiments also relate to display modules, and more particularly, to display modules in which a light source element for emitting light into a light guide panel may be easily installed.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A display module, comprising:
a display panel that displays an image;
a backlight including a light guide panel that guides light onto the display panel and an optical unit including a circuit board, the circuit board having mounted thereon a plurality of light source elements that supply light into the light guide panel; and
a housing unit including a mold frame, the light guide panel being accommodated in the mold frame, the mold frame including:
at least one accommodation groove in which the light source elements are accommodated, and
a separation preventing portion on an inner sidewall of the mold frame that is in contact with the at least one accommodation groove.

2. The display module of claim 1, wherein a side portion of the light guide panel is in front of the light source elements, and the separation preventing portion is disposed behind the light source elements.

3. The display module of claim 2, wherein the separation preventing portion is on the inner sidewall of the mold frame and the inner sidewall corresponds to a rear surface of the light source elements opposite to the side portion of the light guide panel.

4. The display module of claim 3, wherein the separation preventing portion is a protrusion protruded from the inner sidewall.

5. The display module of claim 4, wherein a surface of the separation preventing portion corresponding to the rear surface of the light source elements is curved.

6. The display module of claim 1, wherein the separation preventing portion and the mold frame are formed of a same material.

7. The display module of claim 1, wherein the separation preventing portion is formed with the mold frame as a single unit.

8. The display module of claim 1, wherein the separation preventing portion is formed of an elastic material.

9. The display module of claim 1, wherein a plurality of the accommodation grooves are spaced apart at predetermined intervals along a side of the mold frame, and the separation preventing portion is in an outermost accommodation groove among the plurality of accommodation grooves.

10. The display module of claim 1, wherein the separation preventing portion is a protrusion on the inner sidewall of the mold frame and the inner sidewall corresponds to a rear surface of the light source elements opposite to a side portion of the light guide panel.

11. The display module of claim 10, wherein a surface of the separation preventing portion corresponding to the rear surface of the light source element is curved.

12. The display module of claim 1, wherein the circuit board is a flexible substrate.

13. The display module of claim 1, wherein a portion of the mold frame in which the accommodation groove is formed has a concave-convex structure along a side of the mold frame.

14. The display module of claim 1, wherein:
an accommodation portion is on an edge of a sidewall portion of the mold frame, and
the accommodation portion includes a flat panel portion that is curved from an end portion of the sidewall portion, a plurality of convex portions protruded from a front edge of the flat panel portion toward the light guide panel, and a plurality of the accommodation grooves between adjacent convex portions and in which the light source elements are disposed.

15. The display module of claim 14, wherein the circuit board surrounds an external surface of the sidewall portion of the mold frame and is above the accommodation portion, and the plurality of light source elements arranged on the circuit board are separately located in the accommodation grooves.

16. The display module of claim 14, wherein the separation preventing portion is in the form of a protrusion protruding from an inner sidewall of the flat panel portion corresponding to a rear surface of the light source elements opposite to a side portion of the light guide panel.

17. The display module of claim 16, wherein a surface of the separation preventing portion corresponding to the rear surface of the light source elements is curved.

18. The display module of claim 14, wherein a plurality of the accommodation grooves are spaced apart at predetermined intervals along a side of the mold frame, and the separation preventing portion is in the form of a protrusion protruding from an inner sidewall of the flat panel portion in an outermost accommodation groove among the plurality of accommodation grooves.

19. The display module of claim 1, further comprising a case installed under the mold frame and accommodating the mold frame.

20. The display module of claim 1, wherein at least one optical sheet is interposed between the display panel and the light guide panel, and a reflection sheet is on a rear surface of the light guide panel opposite to the at least one optical sheet.
